(19) United States
(12) Patent Application Publication
(10) Pub. No.: US 2005/0228519 A1
(43) Pub. Date: Oct. 13, 2005

(54) Method for personal parameter list management for an audio and/or video device

(75) Inventors: Daniel Graf, Vienna (AT); Ramon De La Fuente, Cupertino, CA (US); Daniel Meirsman, Sunnyvale, CA (US); Jean-Marc Dominique Matteini, Saratoga, CA (US); Arjan Van Ham, San Jose, CA (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/500,605

(22) PCT Filed: Dec. 16, 2002
(86) PCT No.: PCT/IB02/05456

§ 371 Date: Jun. 30, 2004

(30) Foreign Application Priority Data
Jan. 6, 2002 (EP) 02000028.7

(51) Int. Cl. G06F 17/00

(52) U.S. Cl. 700/94

(57) ABSTRACT

In a method for the personal management of parameter lists for an audio and/or video device (2a, 2b) by at least one user, an access facility (5a, 5b) is used to access, via a data network (7), a storage facility (4) connected to the audio and/or video device (2a, 2b), which storage facility (4) stores the parameter lists to be managed, which contain parameters for the audio and/or video device (2a, 2b), the access facility (5a, 5b) enabling amendment of the parameter lists to be managed in respect of the list entries contained therein.

The invention relates to a method for the personal management of parameter lists for an audio and/or video device by at least one user of the audio and/or video device, said parameter lists relate to parameters for the audio and/or video device, and contain list entries, wherein at least part of a parameter list is displayed, or can be displayed by means of the audio and/or video device.

The invention also relates to a storage facility for an audio and/or video device wherein parameter lists for the audio and/or video device stored in the storage facility can be displayed.

The invention also relates to an audio and/or video device with which parameter lists for the audio and/or video device can be displayed.

A method as set forth in the first paragraph has become known in connection with an audio device marketed by the applicant under type designation FW-i1000. This device is an Internet-capable audio device which, in addition to other functions, is capable of reproducing radio programs broadcast via the Internet. In this known device, parameter lists stored in a storage facility provided in the device can only be input and modified in a complex manner, requiring considerable operational involvement, by means of input means provided on the device. The known device also has the limitation that practically only a sole user of the known device can define and manage favorites, i.e. favorite songs stored, for example, on a CD, this is a disadvantage in cases such as frequently occur in practice, where the known device is used by several users, since the definition of favorites assigned to one user cannot be made for more than one user. A further limitation of the known device consists in that parameter lists desired by many users cannot be input at all and are, therefore, unavailable.

It is an object of the invention to eliminate the above difficulties and the above limitations, and to provide an improved method and an improved storage facility as well as an improved audio and/or video device. It is a further object of the invention to realize a storage facility which is provided for an improved audio and/or video device of this kind, and which is suitable for storing parameter lists that can be managed in a simple manner.

To achieve the object specified above, features according to the invention are provided for a method according to the invention, so that a method according to the invention can be characterized as follows:

A method for the personal management of parameter lists for an audio and/or video device by at least one user of the audio and/or video device, said parameter lists relate to parameters for the audio and/or video device and contain list entries, wherein at least part of a parameter list is displayed by means of the audio and/or video device, and wherein using an access facility, a storage facility connected to the audio and/or video device via a data network is accessed, said storage facility stores the parameter lists to be managed for the audio and/or video device, and wherein using the access facility, the parameter lists to be managed for the audio and/or video device are amended in respect of the list entries contained therein.

To achieve the above object, features according to the invention are provided in a storage facility according to the invention, so that a storage facility according to the invention can be characterized as follows:

A storage facility, said storage facility being provided and designed for communication with at least one audio and/or video device via a data network and for communication with at least one access facility via a data network, and in said storage facility manageable parameter lists for the at least one audio and/or video device can be stored, said manageable parameter lists relate to the at least one audio and/or video device and contain list entries, and said storage facility, by means of the at least one access facility, the manageable parameter lists for the at least one audio and/or video device can be amended in respect of the list entries contained therein, and from said storage facility the manageable parameter lists can be retrieved with the aid of the at least one audio and/or video device.

To achieve the above object, features according to the invention are provided in an audio and/or video device according to the invention, so that an audio and/or video device according to the invention can be characterized as follows:

An audio and/or video device, said audio and/or video device being provided and designed for communication with a storage facility via a data network, and said audio and/or video device being equipped with connecting means that are provided and designed for establishing a communications connection with the storage facility, said storage facility stores manageable parameter lists for the audio and/or video device, said manageable parameter lists relate to the audio and/or video device and contain list entries and can be amended in respect of the list entries contained therein by means of at least one access facility which is connected to the storage facility via a data network, and said audio and/or video device being equipped with reviewing means which are provided and designed for reviewing the manageable parameter lists from the storage facility.

The provision of the features according to the invention creates the possibility of managing (completely impossible until now) a multiplicity of parameter lists for an audio and/or video device in a very simple, user-friendly manner, in this context the management of parameter lists is to be understood to mean that existing parameter lists are amended in a simple manner, and that any new parameter lists that may be desired by a user or consumer are created. Through the provision of the features according to the invention, it is advantageously achieved that the selection of a list entry from a parameter list displayed with the aid of an audio and/or video device, which selection is possible in a simple manner with only minimum involvement and can be undertaken directly on the audio and/or video device, whereas the management of the parameter lists, which requires a high degree of involvement and many inputs, can be undertaken with the aid of an access facility provided separately from the audio and/or video device which access facility enables accessing of the storage facility containing the parameter lists to be managed. In the event that the parameter lists are very extensive and consequently require a relatively large storage capacity, a further advantage exists in the fact that the parameter lists are not contained in an audio and/or video device but in a storage facility which is separate from the audio and/or video device, so that a relatively small storage capacity suffices for the audio and/or video appliance. An additional advantage is obtained because, owing to the fact that management of the parameter lists with the aid of the audio and/or video device is dispensed with, a reduced complexity of the control means of the audio and/or video appliance is possible and, as a result, simpler control means will suffice.

In a method according to the invention, the accessing of the storage facility may take place with the aid of the access facility, and the communication between an audio and/or video device and the storage facility may take place via two different data networks. It has, however, proved particularly advantageous if, in addition, the measures as disclosed in claim 2 are taken. This is advantageous in respect of realizing an as simple as possible system configuration.

In a method according to the invention, it has also proved advantageous if, in addition, the measures as disclosed in claim 3 and/or the measures as disclosed in claim 4 are taken. As a result, it is ensured that the amendments most frequently desired can be made.

In a method according to the invention, the amending of parameter lists may be undertaken by persons authorized to do so by a user of an audio and/or video device. It has, however, proved particularly advantageous if the amendment of the parameter lists is undertaken by the at least one user of an audio and/or video device. In practice, this has proved to be the simplest and most efficient option.

In a storage facility according to the invention, it has proved particularly advantageous if, in addition, the measures as disclosed in claim 7 are taken. This is advantageous in respect of easy access to the stored parameter lists with already existing means and virtually without additional involvement.

In an audio and/or video appliance according to the invention, it has proved advantageous if the retrieving means are equipped with a retrieving button that can be operated by hand. This is advantageous in respect of a simple, reasonably-priced structural design. It should, however, be mentioned that the retrieving means may also be designed without a retrieving button that can be operated by hand, and may, for example, contain a detection facility for detecting the occurrence of a supply voltage in the audio and/or video device, which detection facility, after recognizing the occurrence of the said supply voltage, generates control information with the aid of which the retrieving of the manageable parameter lists from the storage facility can be initiated automatically.

The aspects cited above and further aspects of the invention are illustrated and further explained on the basis of the embodiment described below.

The invention will be further described with reference to an embodiment shown in the drawing, to which, however, the invention is not restricted.

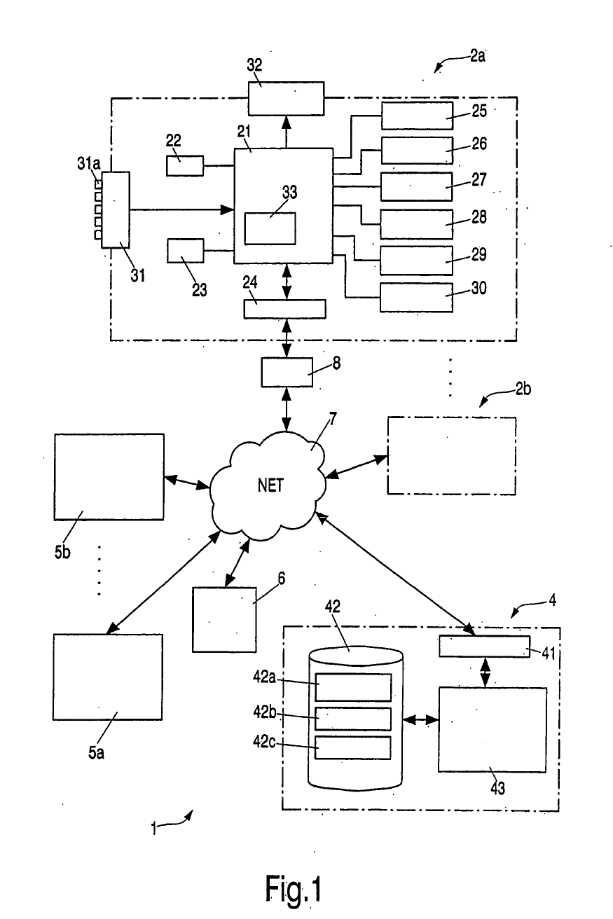

FIG. 1 shows a highly schematized representation, in the form of a block diagram, of a system with a plurality of audio devices and a storage facility for parameter lists for these audio devices, and a plurality of access facilities for accessing the storage facility.

FIG. 1 shows a system 1. System 1 contains a plurality of audio devices, only two of which that is, the audio devices 2a and 2b, are shown, and a storage facility 4 for storing parameter lists for the audio devices 2a and 2b, and multiple access facilities for accessing the storage facility 4, of which access facilities only two access facilities 5a and 5b are shown. The system 1 also contains a data network 7 and a modem 8, via which data network 7 and modem 8 the audio device 2a is connected to the storage facility 4 and can communicate. The data network 7 is in this case the Internet, i.e. the worldwide data network for a packet-switching data exchange. The access facilities 5a and 5b are likewise connected to the storage facility 4 via the data network 7 in order to be able to communicate with the storage facility 4. Also connected to the data network 7 is a so-called service provider 6, which offers a multiplicity of reception programs via the data network 7. The audio devices 2a and 2b are suitable for undertaking the reproduction of radio programs and the reproduction of an audio signal, and, if applicable, the recording of an audio signal from, or onto, a circular-disk-shaped recording medium with optical scanning capability, and the reproduction and recording of an audio signal from, or onto, a magnetic tape accommodated in a cassette, and the reproduction of an audio signal from a record.

The audio device 2a is equipped with a data network interface 24, which data network interface 24 is designed for communicating data via modem 8 and data network 7, and is capable of running appropriate communication protocols for this purpose. A communication protocol of this kind satisfies, for example, the standard IEEE 802.11b, which is well known in specialist circles; therefore, no further details will be given here. It may be mentioned that modem 8 may be a broadband cable modem or a modem for a DSL system, which is sufficiently well known in specialist circles; therefore, no further details will be given here. It may also be mentioned that the data transmission between the data network interface 24 and the modem 8 may also take place in a different manner, e.g. in a wireless manner. The data network interface 24 is connected to a system controller 21, which system controller 21 is connected to a series of data processing means, and is designed to control these data processing means, further details of which are given below.

According to an embodiment of the invention, the system controller 21 is connected to a plurality of means, that is a tuner module 25, which is designed for receiving radio programs from various radio stations, and a CD module 26, which is designed for reproducing and/or recording of, or onto, compact disks (CDs), and an Internet audio module 28, which is designed for reproducing radio programs which are transmitted via the data network 7, and a tape module 29, which is designed for reproducing and/or recording of, or onto, a magnetic tape accommodated in a cassette, and an ancillary-equipment module 30, which is designed for interaction with further reproduction and/or recording facilities not shown here, and an amplifier module 27, which is designed for amplifying audio signals. An amplified audio signal can be applied to a loudspeaker not shown here. The system controller 21 contains source selection means 33, with the aid of which each of the modules 25 to 30, and thereby pieces of music to be reproduced or recorded, can be selected. The system controller 21 is also connected to input means 31, which input means 31 are designed for inputting control information, and to output means 32, which output means 32 are designed for delivering output signals. In the present case, the input means 31 are buttons. It may be mentioned that input means 31 of this kind may also be formed by a multifunctional remote control means, a language control means or a personal computer (PC). In the present case, the output means 32 is a dot matrix display. It may be mentioned that output means 32 of this kind may also be formed by an LCD display or a starburst display. Also connected to the system controller 21 are a non-volatile memory EPROM 22 and a volatile memory RAM 23.

The storage facility 4 is formed by a server and equipped with a web interface 41, which web interface 41 is designed for communicating data via the data network 7, i.e. via the Internet, and is capable of running appropriate communication protocols (SMTP, HTTP for example). A web interface 41 of this kind is well known in specialist circles, for which reason no further details will be given here. The storage facility 4 is also equipped with a database 42, which is designed inter alia for storing parameter lists and data relevant to the audio devices 2a and 2b. The storage facility 4 also includes database processing means 43, which are connected to the database 42 and the web interface 41, and designed for processing and controlling said data. The database 42 is equipped inter alia with the following storage means: user profile storage means 42a, which are designed for storing a user profile, web page storage means 42b, which are designed for storing web pages or Internet sites which can be viewed or called up by a user, and parameter list storage means 42c, which are provided and designed for storing parameter lists relevant to the audio devices 2a and 2b.

In the present case, the access facilities 5a and 5b are personal computers (PCs), which, like the storage facility 4, are equipped with a web interface (not shown here), which web interface is designed for communicating data via data network 7 and capable of running corresponding communication protocols. It may be mentioned that the access facilities 5a and 5b may each also be formed by a portable PC or another portable computer with a web interface. On each PC forming an access facility 5a or 5b, management of the parameter lists stored in the storage facility 4 can be undertaken by executing an Internet browser, which is, for example, Netscape Navigator or Microsoft Internet Explorer or Opera. By calling up a so-called “Uniform Resource Identifier” (URI), which may be a URL (Uniform Resource Locator) or a URN (Universal Resource Name), as, for example, in the present case, by calling up http://my.philips.com, access is gained to the web pages stored in the web page storage means 42b, which enable a graphics representation or a layout of the parameter lists or data stored for the audio devices 2a and 2b, in the present case a start web page always being displayed for a first-time access. The web pages are coded in HTML (Hypertext Markup Language) or XHTML (expanded form of HTML). It may be mentioned that the web pages may be coded in a different manner, for example in XML (Extensible Markup Language). It may be further mentioned that the said web pages may be stored, at least partly or as a whole, in other storage facilities or servers, which are also connected to the data network 7, i.e. to the Internet, specifically in the access facilities 5a and/or 5b, storage means provided for this purpose then being included in the access facilities 5a and/or 5b.

On the start web page, a verification of the user or consumer, i.e. a log-on, may be necessary for an authorized use of further web pages; a user name and a password then have to be entered. When the use by the user takes place for the first time, the user has the opportunity of registering with the system, i.e. setting up an account in the system. For an owner of an audio device 2a and/or 2b, this is done by specifying or registering a valid e-mail address. Registration may be undertaken by the user himself or by a system administrator or the person responsible for the storage facility 4. The registration data is stored in the user-data storage means 42a. Similar methods of registering or logging-on are sufficiently well known in specialist circles; therefore, no further details will be given here.

The screenshot 1 shown below gives an example of a web page which is displayed in the Internet browser after a user has logged on. In the left-hand, dark area of screenshot 1, a directory with entries is shown; the directory entries lead via hyperlinks or cross-references to other web pages, the directory, however, remaining visible.

[image]

Screenshot 2 below shows a web page which appears by calling up the cross-reference of the directory entry “---CDs” in the Internet browser as shown in screenshot 1. In the right-hand section, next to the directory of screenshot 2, there is a CD parameter list whose data or parameter-list entries are stored in the parameter-list storage means 42c. The CD parameter-list entries may be expanded by the audio device 2a in that a CD as yet unknown in the system is inserted in the CD module 26 and then reproduced, CD parameter-list entries then being generated and transmitted to the storage facility 4. From a CD, for example, so-called CD meta data stored in it may be read and transmitted to the storage facility 4. This CD meta data may be, for example, ISO meta data or ID3 meta data in the case of an MP3 CD. The possibility of sorting the CD parameter-list entries also exists. In the present case, they are sorted by artists. There is also a possibility of sorting by genre or by CDs existing in the so-called MP3 format, or simply displaying all CDs.

[image]

The CD parameter-list entries may refer by hyperlinks to other web pages. For example, by selecting the entries “Portishead” and “Dummy” according to the screenshot 2, a web page is displayed as shown in screenshot 3 below. In the said screenshot 3, inter alia two parameter lists are displayed, i.e. a CD-contents parameter list with the heading “All Tracks” and a favorites parameter list with the heading “Favorites logo from set”. The CD-contents parameter list contains all music titles of the relevant CD as well as timings for the music titles. The user now has the opportunity to mark list entries in the CD-contents parameter list, and thereby define his favorites on this CD. It may be mentioned that the order of the favorites defined can be amended if required. An action which is executed following activation of the area identified with “Save” in the screenshot 3, transfers the marked list entries in the CD-contents parameter list to the favorites parameter list, which favorites parameter list will be, or is, also stored in parameter-list storage means 42c. The favorites parameter list is transmitted from the storage facility 4 to the audio device 2a or 2b following activation in the audio device 2a or 2b. The transmitted favorites parameter list serves for the selection of music titles on a CD in question as soon as the said CD is reproduced again by the CD module.

[image]

By calling up the cross-reference of the directory entry “---Internet Audio” an Internet Audio web page is called up and displayed, as shown in, for example, screenshot 4. The user is enabled to manage so-called services by means of this Internet Audio web page. As can be seen from the screenshot 4, when a service is selected from a drop-down field entitled “Services”, which represents a services parameter list, a station parameter list is filled with list entries, which station parameter list contains the stations or reception programs offered for the selected service, and additional information, such as genre, bit rate or information concerning reliability. In the case shown in the screenshot 4, the station parameter list is occupied by stations of the known service “MusicMatch MX”. Examples of further services are “iM Radio” or “MP3.com” or “AOL Music” to name just a few. It may be mentioned that the list entries on the station parameter list can be sorted by, for example, genre, region or language, or by popularity or by personal or other criteria. The user now has the opportunity of marking list entries on the station parameter list and thereby defining his favorite stations for the service. By means of a storage action, the marked list entries in the station parameter list are transferred to a favorite stations parameter list, which favorite stations parameter list is also stored in the parameter-list storage means 42c. Following an activation in the audio device 2a or 2b, the favorite stations parameter list is sent from the storage facility 4 to the appropriate audio device 2a or 2b. An expansion of the service parameter list is enabled in a very simple manner by calling up a service addition web page, a URL, a station name, the genre, the language and/or other additional information then being given and stored. For added services of this kind, user fees or registration fees may be demanded, which may be dealt with immediately by means of an online payment transaction for which personal information stored in user-data storage means 42a, such as name, address and credit card number may be accessed.

[image]

By calling up the cross-reference of the directory entry “---My Stereos”, a MyStereos web page is called up and displayed, as shown in, for example, screenshot 5. This MyStereos web page enables the user to manage his audio devices 2a or 2b. In the example shown in the screenshot 5, a user or consumer possesses two audio devices 2a and 2b, which are identified or designated as “Work-Office Stereo” and “Home-Living Room”. Calling up or activating a “Rename” function, enables an amendment of the designation of the audio devices. Furthermore, an addition or removal of additional users for the particular audio device 2a and/or 2b is enabled by activating an “Add/Remove Users” function, whereby a cross-reference is made to a user-amendment web page.

[image]

A user-amendment web page of this kind is shown in, for example, screenshot 6. In the said screenshot 6, inter alia two parameter lists are shown, i.e. an all-users parameter list with a heading “All Users” and a current-users parameter list with a heading “Current Users”. A new user is added by activating a “Create New User” function in the All Users parameter list, reference then being made to an input web page where data can be input, for example the name and an e-mail address of the newly added user, and any further information, such as information as to whether the new user already has his own account in the system, i.e. is registered, and user authorizations being defined, such as an authorization to add or remove further users, or an authorization to call up and/or acquire special services. The current users parameter list is sent from the storage facility 4 to the relevant audio device 2a or 2b after an activation in the audio device 2a or 2b.

On the MyStereos web page, a software update can also be performed by activation of a “Software Update” function, either automatically or through the manual generation of suitable control information, during which software update updated software is sent from the storage facility 4 to the audio device 2a or 2b; this updated software, for example, amends existing operational functions, in particular improves them, or enables additional operational functions. An additional operational function of this kind may be subject to a fee.

[image]

By calling up the cross-reference in directory entry “---My Account”, a MyAccount web page is called up and displayed. With the aid of this MyAccount web page, a user's personal data can be amended in the user-data storage means 42a, for example a password for access to the account or the name, address, telephone number, e-mail address, sex or age of the user, or credit card details.

By calling up the directory entry “---Info! Requests”, an InfoRequest web page is called up and displayed. With the aid of this InfoRequest web page, by actuating a button of the input means 31 of the audio device 2a during the reproduction of an audio signal offered by a signal source, the additional information requested that relates to this audio signal, which may be text and/or sound and/or image information, can be displayed. The additional information requested and called up and then received may be stored in, for example, the storage facility 4.

An operational procedure that frequently occurs in an audio device 2a is briefly described below.

Following purchase of the audio device 2a by the user, the user connects the audio device 2a to the data network 7, after which the user can create and manage the parameter lists described above in a user-friendly manner with the aid of the access facility 5a and the storage facility 4. Subsequently, with the aid of a connect button 31a contained in the input means 31, the user can make a communications connection with the storage facility 4 via the data network 7 in order to retrieve from the storage facility 4 a required parameter list. Depending on the purpose, a retrieved parameter list is stored in the EPROM 22 or the RAM 23, after which part of the retrieved parameter list is displayed with the aid of the display means 32. With the aid of a selection criterion generated for the purpose, a list entry is then selected from the displayed part of a parameter list with the audio device 2a. The audio device 2a is then activated according to the selected list entry. The activation may result in the enabling of the audio device 2a for an authorized user and the reproduction or recording of audio signals or the amendment of reproduction and/or recording parameters.

In the system 1 described above, the access facilities 5a and 5b are directly connected to the data network 7 in order to be able to communicate with the storage facility 4. Each access facility 5a and 5b contains interface means for connecting to the data network 7. This offers the advantage that each access facility 5a and 5b can be provided with local separation from each audio device 2a and 2b. If an audio device 2a and an associated access facility 5a are provided locally adjacent to one another, it is advantageous to connect the access facility 5a to the data network 7 via the modem 8 of the audio device 2a, as a result of which separate interface means are advantageously dispensed with in the access facility 5a.

In the system 1 described above, the storage facility 4 is designed as one unit. A storage facility of this kind may, however, also be realized as a so-called distributed storage facility; at least one parameter list is then stored, for example, at each locally distributed server. A storage facility of this kind may contain several servers.

It may be mentioned that the management of parameter lists is also possible and advantageous in association with MP3 recording, since in this case structured parameter lists can be advantageously produced for pieces of music.

It may be mentioned that, instead of audio devices that are only suitable for audio-signal processing, a system 1 of this kind may also contain video devices suitable for video-signal processing, or audio/video devices suitable for both audio-signal processing and video-signal processing, with the aid of which a video-signal reproduction and, if applicable, recording, can be undertaken.

1. A method for the personal management of parameter lists for an audio and/or video device (2a, 2b) by at least one user of the audio and/or video device (2a, 2b),
said parameter lists relate to parameters for the audio and/or video device (2a, 2b) and contain list entries,
wherein at least part of a parameter list is displayed by means of the audio and/or video device (2a, 2b,) and
wherein using an access facility (5a, 5b), a storage facility (4) connected to the audio and/or video device (2a, 2b) via a data network (7) is accessed, via a data network (7), said storage facility (4) stores the parameter lists to be managed for the audio and/or video device (2a, 2b), and
wherein using the access facility (5a, 5b), the parameter lists to be managed for the audio and/or video device (2a, 2b) are amended in respect of the list entries contained therein.

2. A method as claimed in claim 1, wherein the access to the storage facility (4) takes place by means of the access facility (5a, 5b), via the same data network (7) via which the audio and/or video device (2a, 2b) is connected to the storage facility (4).

3. A method as claimed in claim 1, wherein, in the course of amending the parameter lists for the audio and/or video device (2a, 2b), deletion and/or addition and/or relocation of at least one list entry is undertaken.

4. A method as claimed in claim 1, wherein, in the course of amending the parameter lists for the audio and/or video device (2a, 2b), an addition of at least one parameter list that is new as compared with the already existing parameter lists and/or a deletion of at least one already existing parameter list is undertaken.

5. A method as claimed in claim 1, wherein the amendment of the parameter lists is undertaken by the at least one user.

6. A storage facility (4),
said storage facility (4) being provided and designed for communication with at least one audio and/or video device (2a, 2b) via a data network (7) and for communication with at least one access facility (5a, 5b) via a data network (7), and
in said storage facility (4) manageable parameter lists for the at least one audio and/or video device (2a, 2b) can be stored, said manageable parameter lists relate to the at least one audio and/or video device (2a, 2b) and contain list entries, and in said storage facility (4) by means of the at least one access facility (5a, 5b), the manageable parameter lists for the at least one audio and/or video device (2a, 2b) can be amended in respect of the list entries contained therein, and
from said storage facility (4) the manageable parameter lists can be retrieved with the aid of the at least one audio and/or video device (2a, 2b).

7. A storage facility (4) as claimed in claim 6, wherein the storage facility (4) stores a layout enabling the display of the manageable parameter lists for the purpose of amending the parameter lists.

8. An audio and/or video device (2a, 2b),
said audio and/or video device (2a, 2b) being provided and designed for communication with a storage facility (4) via a data network (7), and
said audio and/or video device (2a, 2b) being equipped with connecting means (24, 8) that are provided and designed for enabling a communications connection with the storage facility (4), said storage facility (4) stores manageable parameter lists for the audio and/or video device (2a, 2b), said manageable parameter lists relate to the audio and/or video device (2a, 2b) and contain list entries and can be amended in respect of the list entries contained therein by means of at least one access facility (5a, 5b) which is connected to the storage facility (4) via a data network (7), and
said audio and/or video device (2a, 2b) being equipped with retrieving means (21, 31) which are provided and designed for retrieving the manageable parameter lists from the storage facility (4).

9. An audio and/or video device (2a, 2b) as claimed in claim 8, wherein the retrieving means (21, 31) are equipped with a retrieving button (31a) which is operated by hand.
